(19) United States
(12) Patent Application Publication
(10) Pub. No.: US 2023/0037916 A1
(43) Pub. Date: Feb. 9, 2023

(54) LINEAR ISOCYANATE GROUP-CONTAINING POLYMER

(71) Applicant: SIKA TECHNOLOGY AG, Baar (CH)

(72) Inventors: Sven REIMANN, Zürich (CH); Melanie JENNI, Spreitenbach (CH)

(73) Assignee: SIKA TECHNOLOGY AG, Baar (CH)

(21) Appl. No.: 17/784,316

(22) PCT Filed: Jan. 11, 2021
(86) PCT No.: PCT/EP2021/050374

§ 371 Date: Jun. 10, 2022

(30) Foreign Application Priority Data
Feb. 3, 2020 (EP) 20155193.4

(51) Int. Cl. C08G 18/48; C08G 18/76; C08G 18/30; C08G 18/10; C09J 175/08; C09D 175/08

(52) U.S. Cl. CPC C08G 18/4833; C08G 18/10; C08G 18/307; C08G 18/7671; C09D 175/08; C09J 175/08

(57) ABSTRACT

A linear polymer containing isocyanate groups and having an NCO content in the range from 0.3% to 1.5% by weight and a monomeric diisocyanate content of not more than 0.5% by weight, wherein it is obtained from the reaction of at least one monomeric aromatic diisocyanate and a polyether diol having an OH number in the range from 5 to 21 mg KOH/g in an NCO/OH ratio of at least 5/1 and subsequent removal of a majority of the monomeric aromatic diisocyanate by means of a suitable separation method, and to moisture-curing polyurethane compositions having a monomeric diisocyanate content of less than 0.1% by weight, comprising said polymer. The polymer of the invention enables elastic adhesives having high elongation, surprisingly high strength and surprisingly good adhesion to plastic substrates.

### TECHNICAL FIELD

The invention relates to polymers having a low monomer level for moisture-curing polyurethane compositions and to the use thereof as elastic adhesives having good adhesion to plastic substrates.

### STATE OF THE ART

Polyurethane compositions which crosslink through reaction of isocyanate groups with moisture or water and cure to give elastomers are especially used as elastic adhesives or sealants in the construction and manufacturing industry, for example for bonding of components in assembly or for filling joints. Owing to their adhesion and elasticity, they can gently damp and buffer forces acting on the substrates, triggered for instance by vibrations or variations in temperature.

Such polyurethane compositions contain polymers containing isocyanate groups as binders, which are prepared by reacting polyols with monomeric diisocyanates. The polymers thus obtained, on account of chain extension reactions, contain a residual monomeric diisocyanate content, typically in the range from 1% to 3% by weight. Monomeric diisocyanates are potentially harmful to health. Formulations containing monomeric diisocyanates, in particular above a concentration of 0.1% by weight, must be provided with hazard symbols and warning messages on the label and in the data sheets, and in some countries may be subject to regulations in respect of sale and use. There is therefore an interest in polyurethane compositions having a low content of monomers, especially below 0.1% by weight. An attractive route to polymers containing isocyanate groups that have a low monomeric diisocyanate content is to use the monomeric diisocyanate in excess in the preparation of the polymer and then to remove a majority of the unconverted monomeric diisocyanate by means of distillation. This route is particularly easy to implement with monomeric diisocyanates that are of low molecular weight and hence volatile, for example hexane diisocyanate. However, polymers based thereon result in slow curing and low mechanical strength in the products. Polymers based diphenylmethane 4,4'-diisocyanate (4,4'-MDI) enable high strengths coupled with high elasticity. In the case of distillative removal of any monomer excess, however, production is much more demanding on account of the low volatility of 4,4’-MDI.

Elastic adhesives for the bonding of plastic substrates are increasingly being demanded in industry, for example for the bonding of headlamp housings or panorama roofs in vehicles, organic glass in ships or trains, or various components of caravans. The adhesive here is to cure rapidly and reliably, is to be very elastic while having high strength, and is to have a high bond strength without complex pretreatment on the plastic substrate, even under heat and water stress. Adhesives based on polymers having a low monomer level, however, especially also on account of the substantial lack of monomeric diisocyanates, show weaknesses in the buildup of adhesion to plastic substrates.

### SUMMARY OF THE INVENTION

It is therefore an object of the present invention to provide a polymer having a low content of monomeric diisocyanates that enables elastic adhesives having reliable curing and high strength and not having any labeling obligation, and distinctly improves the adhesion thereof to plastic substrates.

This object is achieved by a linear polymer as described in claim 1. The polymer has an NCO content in the range from 0.3% to 1.5% by weight and is based on aromatic monomeric diisocyanates, especially diphenylmethane 4,4'-diisocyanate, and polyether diols having an OH number in the range from 5 to 21 mg KOH/g. The polymer of the invention is linear and of high chain length, with a low monomeric diisocyanate content. It is liquid at room temperature, has comparatively low viscosity, and has excellent storage stability with exclusion of moisture. It enables elastic adhesives having an attractive EHS classification and surprisingly good adhesion on plastic substrates, for example PVC, PMMA or polycarbonate, even under heat and water stress. What is also particularly surprising here is the fact that the polymer of the invention imparts excellent mechanical properties, especially high strength (tensile strength and modulus of elasticity), to the adhesives, which was not to be expected with such long-chain linear polymers. Compared to polymers based on shorter-chain polyether diols, the polymer of the invention, with comparable mechanical properties, achieves significantly better adhesion to plastic substrates.

Further aspects of the invention are the subject of further independent claims. Particularly preferred embodiments of the invention are the subject of the dependent claims.

### Ways of Executing the Invention

The invention provides a linear polymer containing isocyanate groups and having an NCO content in the range from 0.3% to 1.5% by weight and a monomeric diisocyanate content of not more than 0.5% by weight, characterized in that it is obtained from the reaction of at least one monomeric aromatic diisocyanate and a polyether diol having an OH number in the range from 5 to 21 mg KOH/g in an NCO/OH ratio of at least 5/1 and subsequent removal of a majority of the monomeric aromatic diisocyanate by means of a suitable separation method.

"Monomeric diisocyanate" refers to an organic compound having two isocyanate groups separated by a divalent hydrocarbyl radical having 4 to 15 carbon atoms. An "aromatic" isocyanate group refers to one bonded directly to an aromatic carbon atom. Isocyanates having exclusively aromatic isocyanate groups are correspondingly referred to as "aromatic isocyanates".

An "aliphatic" isocyanate group refers to one bonded directly to an aliphatic or cycloaliphatic carbon atom. Isocyanates having exclusively aliphatic isocyanate groups are correspondingly referred to as "aliphatic isocyanates".

A "monomeric aromatic diisocyanate" refers to a monomeric diisocyanate having aromatic isocyanate groups.

"NCO content" refers to the content of isocyanate groups in % by weight. "Molecular weight" refers to the molar mass (in g/mol) of a molecule or a molecule residue. "Average molecular weight" refers to the number-average molecular weight (Mₙ) of a polydisperse mixture of oligomeric or polymeric molecules or molecule residues. It is determined by gel-permeation chromatography (GPC) against polystyrene as standard.

A substance or composition is referred to as "storage-stable" or "storable" when it can be stored at room temperature in a suitable container for a prolonged period, typically for at least 3 months, preferably up to 6 months or longer, without this storage resulting in any change in its application or use properties to an extent relevant to its use.

"Plastic" refers to an organic material based on macromolecules.

"Room temperature" refers to a temperature of 23° C.

All industry standards and norms mentioned in this document relate to the versions valid at the date of first filing.

Percentages by weight (% by weight), abbreviated to wt%, refer to proportions by mass of a constituent of a composition or a molecule, based on the overall composition or the overall molecule, unless stated otherwise. The terms "mass" and "weight" are used synonymously in the present document.

The inventive polymer containing isocyanate groups can also be referred to as prepolymer.

The polymer of the invention preferably has an NCO content in the range from 0.5% to 1.3% by weight, especially 0.7% to 1.1% by weight.

More preferably, the polymer has an NCO content in the range from 0.8% to 1.1% by weight, especially 0.9% to 1.1% by weight. Such a polymer enables particularly storage-stable compositions having very good adhesion to plastic substrates.

The polymer of the invention preferably has a monomeric diisocyanate content of not more than 0.3% by weight, especially not more than 0.2% by weight. Such a polymer is particularly suitable for the production of moisture-curing polyurethane compositions that have a monomeric diisocyanate content of less than 0.1% by weight; these can be safely handled even without special safety precautions and can thus be sold in many countries without hazard labeling.

A suitable monomeric aromatic diisocyanate is especially diphenylmethane 4,4'-diisocyanate, optionally with fractions of diphenylmethane 2,4'- and/or 2,2'-diisocyanate (MDI), tolylene 2,4-diisocyanate or mixtures thereof with tolylene 2,6-diisocyanate (TDI), phenylene 1,4-diisocyanate (PDI), 2,3,5,6-tetramethyl-1,4-diisocyanatobenzene, naphthalene 1,5-diisocyanate (NDI) or 3,3'-dimethyl-4,4'-diisocyanatodiphenyl (TODI).

Among these, preference is given to diphenylmethane 4,4'-diisocyanate or tolylene 2,4-diisocyanate or phenylene 1,4-diisocyanate.

A particularly preferred monomeric aromatic diisocyanate is diphenylmethane 4,4'-diisocyanate (4,4'-MDI). This 4,4'-MDI is of a quality that contains only small fractions of diphenylmethane 2,4'- and/or 2,2'-diisocyanate and is solid at room temperature. It enables adhesives having particularly rapid curing and particularly high strength coupled with high extensibility and elasticity.

The 4,4'-MDI has preferably been distilled and has a purity of at least 95%, especially at least 97.5%.

A commercially available diphenylmethane 4,4'-diisocyanate of this quality is, for example, Desmodur^{®} 44 MC (from Covestro) or Lupranat^{®} MRS or ME (from BASF) or Suprasec^{®} 1400 (from Huntsman).

The polyether diol preferably contains repeat units selected from the group consisting of 1,2-ethyleneoxy, 1,2-propyleneoxy, 1,3-propyleneoxy, 1,2-butyleneoxy and 1,4-butyleneoxy. Preference is given to 1,2-propyleneoxy groups, with or without a certain proportion of 1 ,2-ethyleneoxy groups.

More particularly, the polyether diol contains 80% to 100% by weight of 1,2-propyleneoxy groups and 0% to 20% by weight of 1,2-ethyleneoxy groups.

If the polyether diol contains 1 ,2-ethyleneoxy groups, the 1 ,2-propyleneoxy groups and the 1,2-ethyleneoxy groups each preferably form homogeneous blocks, and the poly(1,2-ethyleneoxy) blocks are at the chain ends.

The polyether diol preferably has an OH number in the range from 6 to 19 mg KOH/g, in particular 9 to 14 mg KOH/g, most preferably 12 to 14 mg KOH/g.

The polyether diol preferably has an average molecular weight Mₙ in the range from 5'500 to 20'000 g/mol, more preferably 6'000 to 18'000 g/mol, especially 8'000 to 12'000 g/mol, most preferably 8'000 to 9'000 g/mol.

The polyether diol preferably has an average OH functionality of at least 1.8, especially at least 1.9. As a result of their production, commercial polyether diols contain a certain content of monools, as a result of which their average OH functionality is typically slightly below 2.

The polyether diol preferably has an unsaturation level of less than 0.02 meq/g, especially less than 0.01 meq/g, measured to ASTM D-2849-69. Polyether diols having an unsaturation level of less than 0.01 meq/g have especially been prepared with the aid of what are called double metal cyanide complex catalysts (DMC catalysts).

The polyether diol more preferably has an OH number in the range from 6 to 19 mg KOH/g, preferably 9 to 14 mg KOH/g, most preferably 12 to 14 mg KOH/g, and an average OH functionality of at least 1.9.

Suitable polyether diols are commercially available, for example as Acclaim^{®} Polyol 8200 N, Acclaim^{®} Polyol 12200 N, Acclaim^{®} Polyol 18200 N (all from Covestro), or Preminol^{®} S 4013 F (from Asahi Glass).

Preferably, the polymer of the invention has an average molecular weight Mₙ in the range from 6'000 to 40'000 g/mol, determined by means of gel permeation chromatography (GPC) versus polystyrene as standard with tetrahydrofuran as mobile phase and refractive index detector.

More preferably, the average molecular weight Mₙ is in the range from 8'000 to 30'000 g/mol, especially 8'000 to 15'000 g/mol.

The polymer of the invention is obtained from the reaction of at least one monomeric aromatic diisocyanate and the polyether diol in an NCO/OH ratio of at least 5/1.

The NCO/OH ratio is preferably in the range from 5/1 to 20/1, more preferably in the range from 6/1 to 15/1, especially in the range from 7/1 to 13/1.

The reaction is preferably conducted with exclusion of moisture at a temperature in the range from 20 to 160° C., especially 40 to 140° C., optionally in the presence of suitable catalysts.

After the reaction, the monomeric diisocyanate remaining in the reaction mixture is removed by means of a suitable separation method down to the residual content described.

A preferred separation method is a distillative method, especially thin-film distillation or short-path distillation, preferably with application of reduced pressure.

Particular preference is given to a multistage method in which the monomeric aromatic diisocyanate is removed in a short-path evaporator with a jacket temperature in the range from 120 to 200° C. and a pressure of 0.001 to 0.5 mbar. In the case of 4,4'-MDI, which is preferred as monomeric aromatic diisocyanate, distillative removal is particularly demanding. It has to be ensured, for example, that the condensate does not solidify and block the system. Preference is given to operating at a jacket temperature in the range from 160 to 200° C. at 0.001 to 0.5 mbar, and condensing the monomer removed at a temperature in the range from 40 to 60° C.

Preference is given to reacting the monomeric aromatic diisocyanate with the polyether diol and subsequently removing the majority of the monomeric diisocyanate remaining in the reaction mixture without the use of solvents or entraining agents.

Preference is given to subsequently reusing the aromatic monomeric diisocyanate removed after the reaction, i.e. using it again for the preparation of polymer containing isocyanate groups.

Most preferably, the polymer containing isocyanate groups has an NCO content in the range from 0.5% to 1.3% by weight and a monomeric diisocyanate content of not more than 0.3% by weight. Such a polymer is particularly suitable for elastic adhesives having good adhesion to plastic substrates, good mechanical properties and good EHS classification.

The polymer of the invention is liquid at room temperature and has comparatively low viscosity. It preferably has a viscosity at 20° C. of not more than 80 Pa·s, especially not more than 70 Pa·s, more preferably not more than 60 Pas. The viscosity is determined here with a cone-plate viscometer at a shear rate of 10 s⁻¹.

In the reaction, the OH groups of the polyether diol react with the isocyanate groups of the monomeric aromatic diisocyanate. This also results in what are called chain extension reactions, in that there is reaction of OH groups and/or isocyanate groups of reaction products between diol and monomeric diisocyanate. The higher the NCO/OH ratio chosen, the lower the level of chain extension reactions that takes place, and the lower the polydispersity and hence also the viscosity of the polymer obtained. A measure of the chain extension reaction is the average molecular weight of the polymer, or the breadth and distribution of the peaks in the GPC analysis. A further measure is the effective NCO content of the polymer freed of monomers relative to the theoretical NCO content calculated from the reaction of every OH group with a monomeric aromatic diisocyanate.

The polymer of the invention preferably contains only a low content of chain-extended components. The NCO content in the polymer of the invention is preferably at least 90%, especially at least 95%, of the theoretical NCO content which is calculated from the addition of one mole of monomeric diisocyanate per mole of OH groups of the polyether diol.

The polymer of the invention has low viscosity, contains a low content of monomeric diisocyanates and is very storage-stable with exclusion of moisture. It is particularly suitable for production of elastic adhesives having rapid curing, high strength, high extensibility and particularly good adhesion to plastic substrates.

The invention further provides a moisture-curing polyurethane composition having a content of monomeric diisocyanates of less than 0.1% by weight, comprising the inventive linear polymer containing isocyanate groups.

The moisture-curing polyurethane composition preferably has a content of polymer of the invention, based on the overall composition, in the range from 5% to 80% by weight, especially 10% to 70% by weight, more preferably 20% to 60% by weight.

In addition to the polymer of the invention, the moisture-curing polyurethane composition may contain at least one additional polymer containing isocyanate groups that does not correspond to the polymer of the invention.

Suitable additional polymers containing isocyanate groups are conventionally prepared polymers or other polymers that have been freed of monomers. Further polymers containing aromatic isocyanate groups are suitable, but also polymers containing aliphatic isocyanate groups.

Suitable further polymers containing isocyanate groups are obtained from the reaction of at least one polyol with a superstoichiometric amount of at least one diisocyanate. The reaction is preferably conducted with exclusion of moisture at a temperature in the range from 20 to 160° C., especially 40 to 140° C., optionally in the presence of suitable catalysts.

The NCO/OH ratio is preferably in the range from 1.3/1 to 10/1. The monomeric diisocyanate remaining in the reaction mixture after reaction of the OH groups can be removed, in particular by distillation.

If monomeric diisocyanate is removed from the polymer by distillation, the NCO/OH ratio in the reaction is preferably within a range from 3/1 to 10/1 and the resulting polymer containing isocyanate groups, after the distillation, contains preferably not more than 0.5% by weight, more preferably not more than 0.3% by weight, of monomeric diisocyanate.

If no monomeric diisocyanate is removed from the polymer, the NCO/OH ratio in the reaction is preferably within a range from 1.3/1 to 2.5/1. Such a polymer contains, in particular, not more than 3.5% by weight, preferably not more than 2% by weight, of monomeric diisocyanate.

Preferred monomeric diisocyanates are the aromatic diisocyanates already mentioned, and also aliphatic or cycloaliphatic diisocyanates, especially MDI, TDI, hexane 1,6-diisocyanate (HDI), isophorone diisocyanate (IPDI) or perhydro(diphenylmethane 2,4’- or 4,4'-diisocyanate) (HMDI), or mixtures thereof. Particular preference is given to 4,4'-MDI, TDI or IPDI.

Suitable polyols are commercially available polyols or mixtures thereof, in particular

polyether polyols, in particular polyoxyalkylene diols and/or polyoxyalkylene triols, in particular polymerization products of ethylene oxide or 1,2-propylene oxide or 1,2- or 2,3-butylene oxide or oxetane or tetrahydrofuran or mixtures thereof, where these may be polymerized with the aid of a starter molecule having two or three active hydrogen atoms, in particular a starter molecule such as water, ammonia or a compound having two or more OH or NH groups, for example ethane-1 ,2-diol, propane-1 ,2- or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol A, hydrogenated bisphenol A, 1,1,1-trimethylolethane, 1,1,1-trimethylolpropane, glycerol or aniline, or mixtures of the abovementioned compounds. Likewise suitable are polyether polyols with polymer particles dispersed therein, in particular those with styrene/acrylonitrile (SAN) particles or polyurea or polyhydrazodicarbonamide (PHD) particles. Preferred polyether polyols are polyoxypropylene diols or polyoxypropylene triols, or what are called ethylene oxide-terminated (EO-capped or EO-tipped) polyoxypropylene diols or triols. The latter are especially obtained by further alkoxylating polyoxypropylene diols or triols, on conclusion of the polypropoxylation reaction, with ethylene oxide, with the result that they have primary hydroxyl groups.

Preferred polyether polyols have a degree of unsaturation of less than 0.02 meq/g, in particular less than 0.01 meq/g.

Polyester polyols, also called oligoesterols, prepared by known processes, in particular the polycondensation of hydroxycarboxylic acids or lactones or the polycondensation of aliphatic and/or aromatic polycarboxylic acids with di- or polyhydric alcohols. Preference is given to polyester diols from the reaction of dihydric alcohols, such as in particular ethane-1,2-diol, diethylene glycol, propane-1,2-diol, dipropylene glycol, butane-1,4-diol, pentane-1,5-diol, hexane-1,6-diol, neopentyl glycol, glycerol, 1,1,1-trimethylolpropane or mixtures of the abovementioned alcohols, with organic dicarboxylic acids or the anhydrides or esters thereof, such as in particular succinic acid, glutaric acid, adipic acid, suberic acid, sebacic acid, dodecanedicarboxylic acid, maleic acid, fumaric acid, phthalic acid, isophthalic acid, terephthalic acid, cyclohexane-1,2-dicarboxylic acid, cyclohexane-1,3-dicarboxylic acid or -1,4-dicarboxylic acid or mixtures of the abovementioned acids, or polyester polyols formed from lactones such as in particular ε-caprolactone. Particular preference is given to polyester polyols formed from adipic acid or sebacic acid or dodecanedicarboxylic acid and hexanediol or neopentyl glycol.

Polycarbonate polyols as obtainable by reaction, for example, of the abovementioned alcohols - used to form the polyester polyols - with dialkyl carbonates, diaryl carbonates or phosgene.

Block copolymers bearing at least two OH groups and having at least two different blocks having polyether, polyester and/or polycarbonate structure of the type described above, in particular polyether polyester polyols.

Polyacrylate or polymethacrylate polyols.

Polyhydroxy-functional fats or oils, for example natural fats and oils, in particular castor oil; or polyols obtained by chemical modification of natural fats and oils -called oleochemical polyols - for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by breakdown processes such as alcoholysis or ozonolysis and subsequent chemical linkage, for example by transesterification or dimerization, of the breakdown products or derivatives thereof thus obtained. Suitable breakdown products of natural fats and oils are in particular fatty acids and fatty alcohols and also fatty acid esters, in particular the methyl esters (FAME), which can be derivatized to hydroxy fatty acid esters, for example by hydroformylation and hydrogenation.

Polyhydrocarbon polyols, also called oligohydrocarbonols, such as in particular polyhydroxy-functional polyolefins, polyisobutylenes, polyisoprenes; polyhydroxy-functional ethylene/propylene, ethylene/butylene or ethylene/propylene/diene copolymers, as produced for example by Kraton Polymers; polyhydroxy-functional polymers of dienes, in particular of 1,3-butadiene, which can in particular also be produced from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene or isoprene, in particular polyhydroxy-functional acrylonitrile/butadiene copolymers, as can in particular be produced from epoxides or amino alcohols and carboxyl-terminated acrylonitrile/butadiene copolymers (commercially available for example under the Hypro® CTBN or CTBNX or ETBN name from Emerald Performance Materials); or hydrogenated polyhydroxy-functional polymers or copolymers of dienes.

Also especially suitable are mixtures of polyols.

Preference is given to polyols having an OH number of at least 22 mg KOH/g and/or polyether triols.

For the production of a polymer containing isocyanate groups, it is also possible to additionally use fractions of di- or polyfunctional alcohols, in particular ethane-1,2-diol, propane-1,2-diol, propane-1,3-diol, 2-methylpropane-1,3-diol, butane-1,2-diol, butane-1,3-diol, butane-1,4-diol, pentane-1,3-diol, pentane-1,5-diol, 3-methylpentane-1,5-diol, neopentyl glycol, dibromoneopentyl glycol, hexane-1,2-diol, hexane-1,6-diol, heptane-1,7-diol, octane-1,2-diol, octane-1,8-diol, 2-ethylhexane-1,3-diol, diethylene glycol, triethylene glycol, dipropylene glycol, tripropylene glycol, cyclohexane-1,3-dimethanol or -1,4-dimethanol, ethoxylated bisphenol A, propoxylated bisphenol A, cyclohexanediol, hydrogenated bisphenol A, dimer fatty acid alcohols, 1,1,1-trimethylolethane, 1,1,1-trimethylolpropane, glycerol, pentaerythritol, sugar alcohols, such as in particular xylitol, sorbitol or mannitol, or sugars, such as in particular sucrose, or alkoxylated derivatives of the alcohols mentioned or mixtures of the alcohols mentioned.

Preferably, the moisture-curing polyurethane composition has a content of polymer of the invention, based on the total amount of polymers containing isocyanate groups in the composition, of at least 25% by weight, preferably at least 40% by weight, especially at least 60% by weight.

Preferably, the moisture-curing polyurethane composition additionally contains at least one branched constituent containing isocyanate groups and having an average NCO functionality of more than 2. Together with the polymer of the invention, this enables good mechanical strength and thermal stability combined with good adhesion to plastic substrates.

Preferably, the branched constituent containing isocyanate groups is selected from the group consisting of oligomeric diisocyanates and branched polymers containing isocyanate groups.

Preferably, the branched constituent containing isocyanate groups has an average NCO functionality in the range from 2.2 to 4, especially 2.3 to 3.5.

Preferred oligomeric diisocyanates are HDI biurets such as Desmodur® N 100 or N 3200 (from Covestro), Tolonate® HDB or HDB-LV (from Vencorex) or Duranate® 24A-100 (from Asahi Kasei); HDI isocyanurates such as Desmodur® N 3300, N 3600 or N 3790 BA (all from Covestro), Tolonate® HDT, HDT-LV or HDT-LV2 (from Vencorex), Duranate® TPA-100 or THA-100 (from Asahi Kasei) or Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates, for example in solution as Desmodur® Z 4470 (from Covestro) or in solid form as Vestanat® T1890/ 100 (from Evonik); TDI oligomers such as Desmodur® IL (from Covestro); or mixed isocyanurates based on TDI/HDI, such as Desmodur® HL (from Covestro), where "HDI" stands for hexane 1 ,6-diisocyanate, "IPDI" for isophorone diisocyanate, and "TDI" for tolylene 2,4-diisocyanate or mixtures thereof with tolylene 2,6-diisocyanate.

Preference is given to branched polymers containing isocyanate groups and having an average NCO functionality in the range from 2.2 to 3, especially 2.3 to 3.

A particularly preferred branched polymer containing isocyanate groups has an NCO content in the range from 1% to 2.5% by weight and a monomeric diisocyanate content of not more than 0.3% by weight, and is obtained from the reaction of 4,4’-MDI or IPDI, especially 4,4’-MDI, with an optionally ethylene oxide-terminated polyoxypropylene triol having an average OH functionality in the range from 2.2 to 3 and an OH number in the range from 20 to 60 mg KOH/g, especially in the range from 22 to 42 mg KOH/g, in an NCO/OH ratio of at least 4/1, and subsequent removal of a majority of the unconverted monomeric diisocyanate.

A further particularly preferred branched polymer containing isocyanate groups is a conventionally prepared polymer having an NCO content in the range from 1.2% to 2.5% by weight, obtained from the reaction of at least one monomeric diisocyanate with at least one polyoxypropylene triol and optionally at least one polyoxypropylene diol, where the triol and the diol optionally contain fractions of 1,2-ethyleneoxy groups, in an NCO/OH ratio in the range from 1.5/1 to 2.2/1. Monomeric diisocyanates that are preferred for this purpose are 4,4'-MDI, TDI or IPDI.

The moisture-curing polyurethane composition may, in addition to the polymer of the invention, contain at least one further linear polymer containing isocyanate groups. Especially preferred for this purpose is a polymer having an NCO content in the range from 1.6% to 2.4% by weight, especially 1.6% to 2.1% by weight, and a monomeric diisocyanate content of not more than 0.3% by weight, obtained from the reaction of 4,4’-MDI with an optionally ethylene oxide-terminated polyoxypropylene diol having an OH number in the range from 23 to 38 mg KOH/g, especially 25 to 32 mg KOH/g, in an NCO/OH ratio of at least 4/1 and subsequent removal of a majority of the unconverted 4,4’-MDI as described above.

Preferably, the moisture-curing polyurethane composition contains linear polymers and branched isocyanate group-containing constituents in a weight ratio in the range from 60/40 to 99/1, preferably 70/30 to 98/2. Within this range, there is a particularly attractive combination of advantageous mechanical properties and good adhesion to plastic substrates.

If the moisture-curing polyurethane composition contains at least one oligomeric diisocyanate, the weight ratio between linear polymers and oligomeric diisocyanates is preferably in the range from 90/10 to 99.5/0.5, preferably 95/5 to 99/1, especially 95/5 to 98/2.

If the moisture-curing polyurethane composition contains at least one branched polymer containing isocyanate groups, the weight ratio between linear polymers and branched polymers is preferably in the range from 60/40 to 95/5, especially 70/30 to 90/10.

In one embodiment of the invention, the moisture-curing polyurethane composition additionally comprises at least one blocked amine.

A suitable blocked amine preferably has at least one aldimino group or oxazolidino group. On contact with moisture, it is hydrolyzed with release of the amino group and reacts with available isocyanate groups, and can promote rapid, blister-free curing, a particularly nontacky surface and/or particularly good mechanical properties.

Preferred oxazolidines are bisoxazolidines, especially those derived from isobutyraldehyde, benzaldehyde or substituted benzaldehyde, especially benzaldehyde substituted in the para position by an optionally branched alkyl group having 10 to 14 carbon atoms.

Preference is given to bisoxazolidines from the reaction of OH-functional monooxazolidines with diisocyanates, especially hexamethylene 1,6-diisocyanate. Suitable monooxazolidines are especially obtained from the reaction of diethanolamine and an aldehyde with release and removal of water.

Suitable aldimines are especially di- or trialdimines from the reaction of commercial primary di- or triamines with non-enolizable aldehydes. These are aldehydes that do not have a hydrogen atom in the alpha position to the carbon atom of the aldehyde group.

Particularly preferred blocked amines are selected from the group consisting of N,N'-bis(2,2-dimethyl-3-lauroyloxypropylidene)hexylene-1,6-diamine, N,N'-bis(2,2-dimethyl-3-acetoxypropylidene)-3-aminomethyl-3,5,5-trimethylcyclohexylamine, N,N'-bis(2,2-dimethyl-3-lauroyloxypropylidene)-3-aminomethyl-3,5,5-trimethylcyclohexylamine, N,N'-bis(benzylidene)-3-aminomethyl-3,5,5-trimethylcyclohexylamine, N,N'-bis(4-C₁₀₋₁₄-alkylbenzylidene)-3-aminomethyl-3,5,5-trimethylcyclohexylamine, N,N'-bis(2,2-dimethyl-3-acetoxypropylidene)polyoxypropylenediamine having an average molecular weight Mₙ in the range from 450 to 750 g/mol, N,N'-bis(2,2-dimethyl-3-lauroyloxypropylidene)polyoxypropylenediamine having an average molecular weight Mₙ in the range from 750 to 1'050 g/mol, N,N'-bis(benzylidene)polyoxypropylenediamine having an average molecular weight Mₙ in the range from 380 to 680 g/mol, N,N'-bis(4-C₁₀₋₁₄-alkylbenzylidene)polyoxypropylenediamine having an average molecular weight Mₙ in the range from 680 to 1'100 g/mol, N,N',N"-tris(2,2-dimethyl-3-acetoxypropylidene)polyoxypropylenetriamine having an average molecular weight Mₙ in the range from 730 to 880 g/mol and N,N',N"-tris(2,2-dimethyl-3-lauroyloxypropylidene)polyoxypropylenetriamine having an average molecular weight Mₙ in the range from 1'150 to 1'300 g/mol.

The moisture-curing polyurethane composition preferably additionally comprises at least one further constituent selected from catalysts, fillers, plasticizers and stabilizers.

Suitable catalysts are catalysts for accelerating the reaction of isocyanate groups, in particular organotin(IV) compounds, such as, in particular, dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), in particular with ligands selected from alkoxides, carboxylates, 1,3-diketonates, oxinate, 1,3-ketoesterates, and 1,3-ketoamidates, or compounds containing tertiary amino groups, such as, in particular, 2,2'-dimorpholinodiethyl ether (DMDEE).

If the moisture-curing polyurethane composition contains blocked amines, suitable catalysts are also catalysts for the hydrolysis of the blocked amino groups, especially organic acids, especially aromatic carboxylic acids such as benzoic acid, 2-nitrobenzoic acid or salicylic acid.

Also especially suitable are combinations of different catalysts.

Suitable fillers are especially ground or precipitated calcium carbonates, optionally coated with fatty acids, especially stearates, barytes, quartz flours, quartz sands, dolomites, wollastonites, calcined kaolins, sheet silicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads.

Preference is given to calcium carbonates that have optionally been coated with fatty acids, especially stearates, calcined kaolins or industrially produced carbon blacks.

Suitable plasticizers are in particular carboxylic esters, such as phthalates, in particular diisononyl phthalate (DINP), diisodecyl phthalate (DIDP) or di(2-propylheptyl)phthalate (DPHP), hydrogenated phthalates or cyclohexane-1,2-dicarboxylate esters, in particular hydrogenated diisononyl phthalate or diisononyl cyclohexane-1,2-dicarboxylate (DINCH), terephthalates, in particular bis(2-ethylhexyl) terephthalate (DOTP) or diisononyl terephthalate (DINT), hydrogenated terephthalates or cyclohexane-1,4-dicarboxylate esters, in particular hydrogenated bis(2-ethylhexyl) terephthalate or bis(2-ethylhexyl) cyclohexane-1,4-dicarboxylate, or hydrogenated diisononyl terephthalate or diisononyl cyclohexane-1,4-dicarboxylate, isophthalates, trimellitates, adipates, in particular dioctyl adipate, azelates, sebacates, benzoates, glycol ethers, glycol esters, plasticizers having polyether structure, in particular polypropylene oxide monools, diols or triols having blocked hydroxyl groups, in particular in the form of acetate groups, organic phosphoric or sulfonic esters, polybutenes, polyisobutenes or plasticizers derived from natural fats or oils, in particular epoxidized soybean or linseed oil.

Preferred plasticizers are phthalates, hydrogenated phthalates, adipates or plasticizers having polyether structure.

Suitable stabilizers are especially stabilizers against oxidation, heat, light or UV radiation. The composition preferably comprises at least one UV stabilizer.

The moisture-curing polyurethane composition may contain further additions, in particular
inorganic or organic pigments, in particular titanium dioxide, chromium oxides or iron oxides;
fibers, in particular glass fibers, carbon fibers, metal fibers, ceramic fibers, polymer fibers, such as polyamide fibers or polyethylene fibers, or natural fibers, such as wool, cellulose, hemp or sisal;
nanofillers such as graphene or carbon nanotubes;
dyes;
desiccants, in particular molecular sieve powders, calcium oxide, highly reactive isocyanates such as p-tosyl isocyanate, monooxazolidines such as Incozol® 2 (from Incorez) or orthoformic esters;
adhesion promoters, in particular organoalkoxysilanes, in particular epoxysilanes, such as in particular 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes, or titanates;
further catalysts that accelerate the reaction of the isocyanate groups;
rheology modifiers, in particular thickeners, in particular sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
solvents, in particular acetone, methyl acetate, tert-butyl acetate, 1-methoxy-2-propyl acetate, ethyl 3-ethoxypropionate, diisopropyl ether, diethylene glycol diethyl ether, ethylene glycol diethyl ether, ethylene glycol monobutyl ether, ethylene glycol mono-2-ethylhexyl ether, acetals such as propylal, butylal, 2-ethylhexylal, dioxolane, glycerol formal or 2,5,7,10-tetraoxaundecane (TOU), toluene, xylene, heptane, octane, naphtha, white spirit, petroleum ether or gasoline, in particular Solvesso™ grades (from Exxon), and propylene carbonate, dimethyl carbonate, butyrolactone, N-methylpyrrolidone, N-ethylpyrrolidone, p-chlorobenzotrifluoride or benzotrifluoride;
natural resins, fats or oils, such as rosin, shellac, linseed oil, castor oil or soybean oil;
nonreactive polymers, in particular homo- or copolymers of unsaturated monomers, in particular from the group comprising ethylene, propylene, butylene, isobutylene, isoprene, vinyl acetate or alkyl (meth)acrylates, in particular polyethylenes (PE), polypropylenes (PP), polyisobutylenes, ethylene/vinyl acetate copolymers (EVA) or atactic poly-α-olefins (APAO);
flame-retardant substances, especially the already mentioned fillers aluminum hydroxide or magnesium hydroxide, or organic phosphoric esters;
additives, in particular wetting agents, leveling agents, defoamers, deaerating agents or biocides;
or further substances customarily used in moisture-curing polyurethane compositions.

It may be advisable to chemically or physically dry certain substances before mixing them into the composition.

When the inventive polymer containing isocyanate groups is mixed with further constituents of the composition, especially fillers, the content of monomeric diisocyanates may be reduced further by reaction with moisture present.

The moisture-curing polyurethane composition preferably contains
30% to 70% by weight of polymers containing isocyanate groups, of which 10% to 70% by weight is polymer of the invention,
20% to 60% by weight of fillers,
0% to 25% by weight, especially 0% to 10% by weight, of plasticizers,
and optionally further constituents, especially oligomeric diisocyanates, blocked amines or catalysts.

The moisture-curing polyurethane composition, after curing, has high strength coupled with high extensibility.

Tensile strength, determined as described in the examples, is preferably at least 1.5 MPa, more preferably at least 2 MPa, especially at least 2.5 MPa.

Modulus of elasticity in the range from 0.05% to 5% elongation, determined as described in the examples, is preferably in the range from 2 to 20 MPa, especially 3 to 15 MPa.

Elongation at break, determined as described in the examples, is preferably at least 300%, especially at least 500%.

The moisture-curing polyurethane composition is in particular produced with exclusion of moisture and stored at ambient temperature in moisture-tight containers. A suitable moisture-tight container especially consists of an optionally coated metal and/or plastic, and is especially a drum, a transport box, a hobbock, a bucket, a canister, a can, a bag, a tubular bag, a cartridge or a tube.

The moisture-curing polyurethane composition may be in the form of a one-component composition or in the form of a multi-component, in particular two-component, composition.

A composition referred to as a "one-component" composition is one in which all constituents of the composition are in the same container and which is storage-stable as is.

A composition referred to as a "two-component" composition is one in which the constituents of the composition are present in two different components that are stored in separate containers and are not mixed with one another until shortly before or during the application of the composition.

The moisture-curing polyurethane composition is preferably a one-component composition. Given suitable packaging and storage, it is storage-stable, typically for several months up to one year or longer.

On application of the moisture-curing polyurethane composition, the curing process commences. This results in the cured composition.

In the case of a one-component composition, it is applied as is and then begins to cure under the influence of moisture or water. For acceleration of the curing, an accelerator component which contains or releases water and/or a catalyst and/or a curing agent can be mixed into the composition on application, or the composition, after application thereof, can be contacted with such an accelerator component.

In the course of curing, the isocyanate groups react with one another under the influence of moisture. If the moisture-curing polyurethane composition contains a blocked amine, the isocyanate groups additionally react with the blocked amino groups as they are hydrolyzed. The totality of these reactions of isocyanate groups that lead to the curing of the composition is also referred to as crosslinking.

The moisture needed for curing the moisture-curing polyurethane composition preferably gets into the composition through diffusion from the air (atmospheric moisture). In the process, a solid layer of cured composition ("skin") is formed on the surfaces of the composition which come into contact with air. Curing proceeds in the direction of diffusion from the outside inward, the skin becoming increasingly thick and ultimately covering the entire composition that was applied. The moisture can also get into the composition additionally or entirely from one or more substrate(s) to which the composition has been applied and/or can come from an accelerator component that is mixed into the composition on application or is contacted therewith after application, for example by painting or spraying.

The moisture-curing polyurethane composition is preferably applied at ambient temperature, in particular within a range from about -10 to 50° C., preferably within a range from -5 to 45° C., in particular 0 to 40° C.

The moisture-curing polyurethane composition is preferably likewise cured at ambient temperature.

The moisture-curing polyurethane composition has a long processing time (open time) and rapid curing.

If the moisture-curing polyurethane composition contains a blocked amine, the aldehyde used for the blocking of the amino groups is released in the course of crosslinking. If this is largely nonvolatile, it will remain for the most part in the cured composition and act as plasticizer.

Preference is given to using the moisture-curing polyurethane composition as elastic adhesive or elastic sealant or elastic coating.

The moisture-curing polyurethane composition as adhesive and/or sealant is especially suitable for bonding and sealing applications in the construction and manufacturing industry or in motor vehicle construction, especially for parquet bonding, assembly, bonding of installable components, module bonding, pane bonding, join sealing, bodywork sealing, seam sealing or cavity sealing.

Elastic bonds in vehicle construction are, for example, the bonded attachment of parts such as plastic covers, trim strips, flanges, fenders, driver's cabins or other installable components to the painted body of a vehicle, or the bonding of panes into the vehicle body, said vehicles especially being automobiles, trucks, buses, rail vehicles or ships.

The moisture-curing polyurethane composition is especially suitable as sealant for the elastic sealing of all kinds of joins, seams or cavities, especially of joins in construction, such as expansion joins or connection joins between structural components, especially components made of plastic, or of floor joins in civil engineering. A sealant having flexible properties and high cold flexibility is particularly suitable especially for the sealing of expansion joins in built structures. As a coating, the moisture-curing polyurethane composition is especially suitable for protection and/or for sealing of built structures or parts thereof, especially in the field of materials made of plastic, especially for balconies, terraces, roofs, especially flat roofs or slightly inclined roof areas or roof gardens, or in building interiors beneath tiles or ceramic plates in wet rooms or kitchens, or in collection pans, conduits, shafts, silos, tanks or wastewater treatment systems.

It can also be used for repair purposes as seal or coating, for example of leaking roof membranes or floor coverings that are no longer fit for purpose, or as repair compound for highly reactive spray seals.

The moisture-curing polyurethane composition can be formulated such that it has a pasty consistency with structurally viscous properties. A composition of this kind is applied by means of a suitable device, for example from commercial cartridges or kegs or hobbocks, for example in the form of a bead, which may have an essentially round or triangular cross-sectional area.

The moisture-curing polyurethane composition can also be formulated such that it is fluid and "self-leveling" or only slightly thixotropic and can be poured out for application. As coating, it can, for example, subsequently be distributed flat up to the desired layer thickness, for example by means of a roller, a slide bar, a toothed applicator or a trowel. In one operation, typically a layer thickness in the range from 0.5 to 3 mm, especially 1 to 2.5 mm, is applied.

Preference is given to using the moisture-curing polyurethane composition as elastic adhesive or elastic sealant or elastic coating for bonding, sealing or coating of at least one plastic substrate.

Suitable plastic substrates are especially rigid and flexible PVC, polycarbonate, polystyrene, polyester, polyamide, PMMA, ABS, SAN, epoxy resins, phenolic resins, PUR, POM, TPO, PE, PP, EPM, EPDM, or blends of polycarbonate and further plastics such as, in particular, ABS and/or SAN, where these plastics may each be in untreated or surface-treated form, treated by means of plasma, corona or flames for example, and fiber-reinforced plastics such as, in particular, carbon fiber-reinforced plastics (CFRP), glass fiber-reinforced plastics (GFRP) or sheet molding compounds (SMC).

Preferably, the plastic substrate is selected from the group consisting of rigid PVC, flexible PVC, polycarbonate, polystyrene, polyester, polyamide, PMMA, ABS,

SAN, epoxy resins, phenolic resins, PUR, POM, TPO, PE, PP, EPM, EPDM, and blends of polycarbonate with further plastics such as, in particular, ABS and/or SAN.

Among these, preference is given to rigid PVC, polycarbonate, blends of polycarbonate with ABS and/or SAN, PMMA or ABS, especially polycarbonate or blends of polycarbonate. These plastics are particularly critical in relation to good adhesion without complex pretreatment, and have to be bonded particularly frequently.

Suitable further substrates which can be bonded or sealed or coated with the moisture-curing polyurethane composition are especially
metals or alloys, such as aluminum, copper, iron, steel, nonferrous metals, including surface-finished metals or alloys, such as zinc-plated or chromium-plated metals;
coated or painted substrates, especially painted tiles, coated concrete, powder-coated metals or alloys or painted metal sheets;
paints or varnishes, especially automotive topcoats;
glass, glass ceramic, concrete, mortar, cement screed, fiber cement, especially fiber cement boards, brick, tile, gypsum, especially gypsum boards or anhydride screed, or natural stone, such as granite or marble;
repair or leveling compounds based on PCC (polymer-modified cement mortar) or ECC (epoxy resin-modified cement mortar);
asphalt or bitumen;
leather, textiles, paper, wood, wood materials bonded with resins, such as phenolic, melamine or epoxy resins, resin/textile composites or further materials called polymer composites;
insulation foams, especially made of EPS, XPS, PUR, PIR, rock wool, glass wool or foamed glass.

If required, the substrates can be pretreated prior to application, especially by physical and/or chemical cleaning methods or the application of an activator or a primer.

It is possible to bond and/or seal two identical or two different substrates.

The moisture-curing polyurethane composition is preferably used in a method of bonding or sealing, comprising the steps of
(i) applying the moisture-curing polyurethane composition described
   to a first substrate and contacting the composition with a second substrate within the open time of the composition, or
   to a first and to a second substrate and joining the two substrates within the open time of the composition, or
   between two substrates,
(ii)curing the composition by contact with moisture.

The moisture-curing polyurethane composition is also preferably used method of coating or sealing, comprising the steps of
(i) applying the moisture-curing polyurethane composition described to a substrate,
(ii)curing the composition by contact with moisture.

In these methods, preferably at least one of the substrates is a plastic substrate, as described above.

The application and curing of the moisture-curing polyurethane composition affords an article bonded or sealed or coated with the composition. This article may be a built structure or a part thereof, especially a built structure in civil engineering above or below ground, a roof, a staircase or a façade, or it may be an industrial good or a consumer good, especially a window, a lamp, a traffic signal, a domestic appliance or a mode of transport, such as, in particular, an automobile, a bus, a caravan, a truck, a rail vehicle, a ship, an aircraft or a helicopter, or an installable component thereof, for example a window made of organic glass, a panorama roof or a lamp housing.

The invention further provides the cured composition obtained from the moisture-curing polyurethane composition after contact thereof with moisture.

The invention further provides an adhesive bond comprising at least one plastic substrate and the composition cured by contact with moisture, as described above.

### EXAMPLES

Working examples are adduced hereinafter, which are intended to further elucidate the invention described. The invention is of course not limited to these described working examples.

"Standard climatic conditions" ("SCC") refer to a temperature of 23 ± 1° C. and a relative air humidity of 50 ± 5%.

Unless stated otherwise, the chemicals used were from Sigma-Aldrich.

Viscosity was measured with a thermostated Rheotec RC30 cone-plate viscometer (cone diameter 25 mm, cone angle 1°, cone tip-plate distance 0.05 mm, shear rate 10 s⁻¹).

Monomeric diisocyanate content was determined by means of HPLC (detection via photodiode array; 0.04 M sodium acetate / acetonitrile as mobile phase) after prior derivatization by means of N-propyl-4-nitrobenzylamine.

Polyols used:
Acclaim® 4200: polyoxypropylene diol, OH number 28 mg KOH/g (from Covestro)
Acclaim® 8200N: polyoxypropylene diol, OH number 14 mg KOH/g (from Covestro)
Acclaim® 12200N: polyoxypropylene diol, OH number 10 mg KOH/g (from Covestro)
Desmophen® 5031 BT: ethylene oxide-terminated polyoxypropylene triol, OH number 28 mg KOH/g (from Covestro)

Monomeric diisocyanates used:
Desmodur^{®} 44 MC L: diphenylmethane 4,4'-diisocyanate having an NCO content of 33.6% by weight (from Covestro)

### Preparation of Polymers Containing Isocyanate Groups

### Polymer L1 (Linear)

757.7 g (0.19 eq OH) of Acclaim® 8200N and 242.3 g (1.9 eq NCO) of Desmodur® 44 MC L were reacted by a known method at 80° C. to give a polymer having an NCO content of 7.2% by weight, a viscosity of 6.8 Pa·s at 20° C. and a monomeric diphenylmethane 4,4'-diisocyanate content of about 20% by weight. Subsequently, the volatile constituents, especially a majority of the monomeric diphenylmethane 4,4'-diisocyanate, were removed by distillation in a short-path evaporator (jacket temperature 180° C., pressure 0.1 to 0.005 mbar, condensation temperature 47° C.). The linear polymer thus obtained had an NCO content of 1.0% by weight, a viscosity of 25.0 Pa·s at 20° C. and a monomeric diphenylmethane 4,4'-diisocyanate content of 0.06% by weight.

### Polymer L2 (Linear)

812.0 g (0.15 eq OH) of Acclaim® 12200 N and 188.0 g (1.5 eq NCO) of Desmodur® 44 MC L were reacted by a known method at 80° C. to give a polymer having an NCO content of 5.6% by weight, a viscosity of 13.9 Pa·s at 20° C. and a monomeric diphenylmethane 4,4'-diisocyanate content of about 14% by weight. Subsequently, the volatile constituents, especially a majority of the monomeric diphenylmethane 4,4'-diisocyanate, were removed by distillation in a short-path evaporator (jacket temperature 180° C., pressure 0.1 to 0.005 mbar, condensation temperature 47° C.). The linear polymer thus obtained had an NCO content of 0.7% by weight, a viscosity of 29.4 Pa·s at 20° C. and a monomeric diphenylmethane 4,4'-diisocyanate content of 0.04% by weight.

### Polymer Ref-1 (Linear, Comparison)

727.0 g of Acclaim® 4200 and 273.0 g of Desmodur® 44 MC L were reacted by a known method at 80° C. to give a polymer having an NCO content of 7.4% by weight, a viscosity of 5.2 Pa·s at 20° C. and a monomeric diphenylmethane 4,4'-diisocyanate content of about 17% by weight.

Subsequently, the volatile constituents, especially a majority of the monomeric diphenylmethane 4,4'-diisocyanate, were removed by distillation in a short-path evaporator (jacket temperature 180° C., pressure 0.1 to 0.005 mbar, condensation temperature 47° C.). The linear polymer thus obtained had an NCO content of 1.8% by weight, a viscosity of 13.3 Pa·s at 20° C. and a monomeric diphenylmethane 4,4'-diisocyanate content of 0.08% by weight.

### Polymer C-1 (Branched)

725.0 g of Desmophen® 5031 BT and 275 g of Desmodur^{®} 44 MC L were reacted by a known method at 80° C. to give a polymer having an NCO content of 7.6% by weight, a viscosity of 6.5 Pa·s at 20° C. and a monomeric diphenylmethane 4,4'-diisocyanate content of about 20% by weight.

Subsequently, the volatile constituents, especially a majority of the monomeric diphenylmethane 4,4'-diisocyanate, were removed by distillation in a short-path evaporator (jacket temperature 180° C., pressure 0.1 to 0.005 mbar, condensation temperature 47° C.). The polymer thus obtained had an NCO content of 1.7% by weight, a viscosity of 19 Pa·s at 20° C. and a monomeric diphenylmethane 4,4'-diisocyanate content of 0.04% by weight.

### Moisture-Curing Polyurethane Compositions

### Compositions Z1 to Z7

For each composition, the ingredients specified in table 1 were mixed in the amounts specified (in parts by weight) by means of a centrifugal mixer

(SpeedMixer™ DAC 150, FlackTek Inc.) with exclusion of moisture at 3000 rpm for one minute and stored with exclusion of moisture. Each composition was tested as follows:

Shore A hardness was determined to DIN 53505 on test specimens cured under standard climatic conditions for 14 days.

To determine the mechanical properties, the composition was applied to a silicone-coated release paper to give a film of thickness 2 mm, which was stored under standard climatic conditions for 14 days, and a few dumbbells having a length of 75 mm with a bar length of 30 mm and a bar width of 4 mm were punched out of the film and these were tested in accordance with DIN EN 53504 at a strain rate of 200 mm/min for tensile strength (breaking force), elongation at break, and 5% modulus of elasticity (at 0.5-5% elongation).

Adhesion to plastic substrates was determined by applying the composition in the form of four parallel beads of width about 10 mm, height 5 mm and length 15 mm to the respective substrate, and curing under standard climatic conditions for 7 days. Subsequently, the adhesion of the cured composition was tested for a first time by making an incision into the first bead at the narrow end just above the bonding surface, holding the cut end of the bead with rounded tweezers and trying to pull the bead away from the substrate. Then the bead was incised again down to the substrate, the part that had been cut away was rolled up with the rounded tweezers and another attempt was made to pull the bead away from the substrate. In this way, the whole bead was cut away from the substrate by pulling. Subsequently, adhesion was assessed from the failure profile and was reported in table 1 under “7d SCC". Some of the test specimens were then stored immersed in deionized water for 7 days, then stored under standard climatic conditions for 2 hours, and then the second bead was cut away from the substrate by pulling with the rounded tweezers and adhesion was assessed from the failure profile and reported in table 1 under “7d H₂O”. Then the test specimens were stored at 80° C. in an air circulation oven for 24 hours, followed by 2 hours under standard climatic conditions, and then the third bead was tested for adhesion as described, and adhesion was assessed from the failure profile and reported in table 1 under “1d 80° C.”. Finally, the test specimens were stored at 70° C. and 100% relative humidity for 7 days, followed by 2 hours under standard climatic conditions, and the fourth bead was tested for adhesion as described, and adhesion was assessed from the failure profile and reported in table 1 under "7d 70° C./100%RH".

The plastic substrates used were the following plastic sheets (300 × 200 × 2 mm):
PMMA: Plexiglas® XT 0A000 (from Evonik Röhm)
PC: Makrolon® GP clear 099 (uncoated polycarbonate, from Covestro)
ABS: Metzoplast ABS/G (from Metzeler Plastics GmbH)
PVC: KömaDur® ES (from Kömmerling Kunststoffe)

Adhesion was assessed under the following scale:

100 represents more than 95% cohesive failure and means very good adhesion.

40 represents 40% cohesive failure and means moderate adhesion.

5 represents 5% cohesive failure and means inadequate adhesion.

0 represents 0% cohesive failure (100% adhesive failure) and means poor adhesion.

The results are reported in table 1.

Comparative examples are identified by (Ref.).

Table 1

Composition (in parts by weight) and properties of Z1 to Z7

| Composition | Z1 (Ref.) | Z2 | Z3 | Z4 | Z5 | Z6 | Z7 |
|---|---|---|---|---|---|---|---|
| Polymer Ref-1 | 41.4 | – | - | | - | - | - |
| Polymer L1 | - | 41.4 | 47.4 | 49.4 | - | - | - |
| Polymer L2 | - | - | - | - | 41.4 | 47.4 | 49.4 |
| Polymer C-1 | 14.0 | 14.0 | 8.0 | 6.0 | 14.0 | 8.0 | 6.0 |
| pTSI¹ | 0.4 | 0.4 | 0.4 | 0.4 | 0.4 | 0.4 | 0.4 |
| Carbon black | 10.0 | 10.0 | 10.0 | 10.0 | 10.0 | 10.0 | 10.0 |
| Chalk² | 32.0 | 32.0 | 32.0 | 32.0 | 32.0 | 32.0 | 32.0 |
| Silica³ | 2.0 | 2.0 | 2.0 | 2.0 | 2.0 | 2.0 | 2.0 |
| DMDEE⁴ | 0.2 | 0.2 | 0.2 | 0.2 | 0.2 | 0.2 | 0.2 |
| Shore A | 44 | 49 | 45 | 45 | 49 | 44 | 40 |
| Tensile strength [MPa] | 6.3 | 6.7 | 3.8 | 2.4 | 5.8 | 4.7 | 1.8 |
| Elongation at break [%] | 900 | 1040 | 1170 | 1135 | 950 | 1200 | 971 |
| Modulus of elasticity 5% [MPa] | 4.3 | 3.9 | 3.8 | 3.8 | 3.8 | 3.3 | 3.3 |
| PMMA adhesion | | | | | | | |
| 7 d SCC | 0 | 100 | 100 | 100 | 100 | 100 | 100 |
| 7d H₂O | 0 | 100 | 100 | 100 | 100 | 100 | 100 |
| 1d 80° C. | 0 | 80 | 100 | 100 | 100 | 100 | 100 |
| 7d 70° C./100%RH | 0 | 100 | 100 | 100 | 100 | 100 | 100 |
| PC adhesion | | | | | | | |
| 7 d SCC | 100 | 100 | 100 | 100 | 100 | 100 | 100 |
| 7d H₂O | 100 | 100 | 100 | 100 | 100 | 100 | 100 |
| 1d 80° C. | 100 | 100 | 100 | 100 | 100 | 100 | 100 |
| 7d 70° C./100%RH | 0 | 0 | 100 | 100 | 0 | 100 | 100 |
| ABS adhesion | | | | | | | |
| 7 d SCC | 0 | 0 | 5 | 100 | 0 | 100 | 100 |
| 7d H₂O | 0 | 0 | 5 | 100 | 0 | 100 | 100 |
| 1d 80° C. | 0 | 0 | 5 | 100 | 0 | 100 | 100 |
| 7d 70° C./100%RH | 0 | 0 | 5 | 100 | 0 | 100 | 100 |
| PVC adhesion | | | | | | | |
| 7 d SCC | 0 | 0 | 5 | 100 | 0 | 100 | 100 |
| 7d H₂O | 0 | 0 | 5 | 100 | 0 | 100 | 100 |
| 1d 80° C. | 0 | 0 | 40 | 100 | 0 | 100 | 100 |
| 7d 70° C./100%RH | 0 | 0 | 100 | 100 | 100 | 100 | 100 |

¹ p-toluenesulfonyl isocyanate ² Omyacarb® 5 GU (from Omya) ³ Aerosil® R 972 (from Evonik) ⁴ 2,2'-dimorpholinodiethyl ether

1. A linear polymer containing isocyanate groups and having an NCO content in the range from 0.3% to 1.5% by weight and a monomeric diisocyanate content of not more than 0.5% by weight, wherein it is obtained from the reaction of at least one monomeric aromatic diisocyanate and a polyether diol having an OH number in the range from 5 to 21 mg KOH/g in an NCO/OH ratio of at least 5/1 and subsequent removal of a majority of the monomeric aromatic diisocyanate by means of a suitable separation method.

2. The polymer as claimed in claim 1, wherein the monomeric aromatic diisocyanate is diphenylmethane 4,4'-diisocyanate.

3. The polymer as claimed in claim 1, wherein the polyether diol contains 80% to 100% by weight of 1,2-propyleneoxy groups and 0% to 20% by weight of 1,2-ethyleneoxy groups.

4. The polymer as claimed in claim 1, wherein the polyether diol has an OH number in the range from 6 to 19 mg KOH/g and an average OH functionality of at least 1.9.

5. The polymer as claimed in claim 1, wherein the excess monomeric diisocyanate is removed by means of a distillative method.

6. The polymer as claimed in claim 1, wherein it has an NCO content in the range from 0.5% to 1.3% by weight and a monomeric diisocyanate content of not more than 0.3% by weight.

7. The polymer as claimed in claim 1, wherein the NCO content is at least 90% of the theoretical NCO content which is calculated from the addition of one mole of monomeric diisocyanate per mole of OH groups of the polyether diol.

8. A moisture-curing polyurethane composition having a monomeric diisocyanate content of less than 0.1% by weight, comprising the polymer as claimed in claim 1.

9. The moisture-curing polyurethane composition as claimed in claim 8, wherein it has a content of polymer containing isocyanate groups and having an NCO content in the range from 0.3% to 1.5% by weight and a monomeric diisocyanate content of not more than 0.5% by weight, wherein it is obtained from the reaction of at least one monomeric aromatic diisocyanate and a polyether diol having an OH number in the range from 5 to 21 mg KOH/g in an NCO/OH ratio of at least 5/1 and subsequent removal of a majority of the monomeric aromatic diisocyanate by means of a suitable separation method, based on the overall composition, in the range from 5% to 80% by weight.

10. The moisture-curing polyurethane composition as claimed in claim 8, wherein it has a content of polymer containing isocyanate groups and having an NCO content in the range from 0.3% to 1.5% by weight and a monomeric diisocyanate content of not more than 0.5% by weight, wherein it is obtained from the reaction of at least one monomeric aromatic diisocyanate and a polyether diol having an OH number in the range from 5 to 21 mg KOH/g in an NCO/OH ratio of at least 5/1 and subsequent removal of a majority of the monomeric aromatic diisocyanate by means of a suitable separation method, based on the total amount of polymers containing isocyanate groups in the composition, of at least 25% by weight.

11. The moisture-curing polyurethane composition as claimed in claim 8, wherein it additionally comprises at least one constituent containing isocyanate groups and having an average NCO functionality of more than 2.

12. A method of bonding, sealing or coating, comprising: obtaining a moisture-curing polyurethane composition as claimed in claim 8; applying it to at least one plastic substrate.

13. The method as claimed in claim 12, wherein the plastic substrate is selected from the group consisting of rigid PVC, flexible PVC, polycarbonate, polystyrene, polyester, polyamide, PMMA, ABS, SAN, epoxy resins, phenolic resins, PUR, POM, TPO, PE, PP, EPM, EPDM, and blends of polycarbonate with further plastics .

14. A cured composition obtained from the moisture-curing polyurethane composition as claimed in claim 8 after contact thereof with moisture.

15. A bonded composite comprising at least one plastic substrate and the polyurethane composition as claimed in claim 8 that has been cured by contact with moisture.
